(19) United States
(12) Patent Application Publication
(10) Pub. No.: US 2026/0132761 A1
(43) Pub. Date: May 14, 2026

(54) THRUSTER FOR ORBITAL MANEUVERS, PROPULSION SYSTEM FOR ORBITAL MANEUVERS AND ORBITAL TRANSPORT VEHICLE

(71) Applicant: D-ORBIT S.P.A., Fino Mornasco (CO) (IT)

(72) Inventors: Davide ZUIN, Fino Mornasco (CO) (IT); Simone LA LUNA, Fino Mornasco (CO) (IT); Lorenzo FERRARIO, Fino Mornasco (CO) (IT)

(21) Appl. No.: 19/118,410

(22) PCT Filed: Oct. 3, 2023
(86) PCT No.: PCT/IB2023/059894

§ 371 Date: Apr. 4, 2025

(30) Foreign Application Priority Data
Oct. 5, 2022 (IT) 102022000020457

(51) Int. Cl. F02K 9/52; F02K 9/60

(52) U.S. Cl. CPC F02K 9/52; F02K 9/60

(57) ABSTRACT

A thruster for orbital maneuvers including a divergent channel with axial axis of symmetry; a combustion chamber; a throat between the combustion chamber and the divergent channel; an injection plate facing the combustion chamber; first injection channels in fluid communication with the combustion chamber, each including an end portion open in the combustion chamber; at least one second injection channel in fluid communication with the combustion chamber, including an end portion open in the combustion chamber; wherein the end portions of the first injection channels are in an annular region extending along injection directions; wherein the end portion of the second injection channel is radially between the axis of symmetry and the end portions of the first injection channels; wherein the injection direction of the end portion of each first injection channel has axial and radial components directed toward the combustion chamber and the axis of symmetry, respectively.

### FIELD OF THE INVENTION

The present invention concerns a thruster for orbital maneuvers, a propulsion system for orbital maneuvers comprising a thruster for orbital maneuvers and an orbital transport vehicle comprising a thruster for orbital maneuvers.

### BACKGROUND

An orbital transport vehicle is a vehicle that can store, transport, and release a payload. Such an orbital transport vehicle is transportable in space aboard a space launcher and has a dedicated propulsion system to perform orbital maneuvers, e.g. orbit change, after release from the space launcher.

The propulsion system of an orbital transport vehicle comprises a thruster for orbital maneuvers and propellant tanks, which feed the thruster with fuel and oxidizer (or comburent).

A thruster for orbital maneuvers usually comprises a combustion chamber within which the combustion of the propellants takes place, an injection plate for injecting the propellants into the combustion chamber, a throat in communication with the combustion chamber and through which the combustion mass, accelerated by the combustion chamber, reaches the speed of sound in a sonic block condition, a divergent channel (or supersonic nozzle) extending from the throat on the opposite side to the combustion chamber and through which the combustion mass is accelerated beyond the speed of sound, and a plurality of cooling channels for cooling the walls of the combustion chamber. A thruster for orbital maneuvers further comprises a feeding system for sending the propellants to the combustion chamber, a spark plug for igniting the combustion, and valves and sensors for controlling the combustion.

In the propulsion systems for bipropellant orbital maneuvers, the propellants can be fed to the combustion chamber through the use of feeding pumps or by pressure through a pressurizing agent such as nitrogen or hydrogen that is used to keep the fuel and oxidizer tanks properly pressurized so that fuel and oxidizer can be made to flow to the combustion chamber with appropriate flow rate and pressure.

Usually, a thruster for orbital maneuvers is switched on for a certain time during a burn, during which the propellants are introduced into the combustion chamber, burned and the generated combusted mass is accelerated and expelled through the throat and the divergent channel. The thruster for orbital maneuvers generates a predetermined force on the orbital transport vehicle for a predetermined time (so as to produce a specific pulse) necessary for completing a predetermined phase of the mission, for example for modifying the orbital parameters of the orbital transport vehicle.

The Applicant has felt the need for an orbital transport vehicle of small dimensions and weight and low costs for the transport and the use of small payloads such as, for example, preferably non-motorized and miniaturized satellites, for example picosatellites or CubeSats. The Applicant has verified that such an orbital transport vehicle, in order to carry out its mission, needs a thruster, of total length (in the thrust direction) of less than 250 mm, of total weight less than 2 Kg capable of generating a propulsive force comprised between 5 N and 22 N for at least 5 continuous seconds, with a thrust efficiency higher than 285 seconds of specific impulse and capable of multiple subsequent ignitions. The Applicant has perceived that the propulsion system for an orbital transport vehicle of this type should be versatile, light, simple, inexpensive and easy to operate.

The Applicant has noted that the production of a thruster for orbital maneuvers of the type summarily described above can be implemented using additive manufacturing techniques such as the selective metal laser melting (Laser Powder Bed Fusion or L-PBF) which allow to produce with low costs most of the thruster in a single block comprising the combustion chamber, the supersonic nozzle and at least part of the feeding system. The Applicant has also verified that it is possible to integrate into the aforementioned single block the cooling channels of the combustion chamber, the injection plate and at least part of the feeding channels that carry the propellants to the injection plate. This production technique requires that the single block be made of a material suitable for additive manufacturing.

The Applicant has observed that handling the propellant for the propulsion system in preparation for the launch normally requires particularly onerous safety procedures and involves non-negligible risks connected with the use of the propellants themselves, with a consequent increase in the deployment times and costs of the orbital transport vehicle and of its payload.

The Applicant has perceived that the use of safe and easy to handle propellants would greatly simplify the operations before launch, reducing the time and the costs required.

The Applicant has noted that the use of the so-called “green propellants”, which are less toxic and safer than the conventional propellants, would allow to further reduce the risks connected with the use of the propellants and would reduce the complexity of the safety procedures.

The Applicant has perceived that if such “green propellants” were self-pressurizing, these could be stored in the respective tanks in liquid form and evaporate during use to keep the pressure in the tank constant during consumption, avoiding the use of additional tanks for the pressurizing agent and consequently reducing the weight of the propulsion system.

The Applicant has found that there is a limited choice of both green and self-pressurizing propellants. In particular, the Applicant has found that nitric oxide (N2O) is the only type of adoptable oxidizer that naturally has the aforementioned characteristics, without the need to be previously decomposed through a decomposition system (e.g. electrolysis or pre-heating) and without the need for other elements dissolved inside to become self-pressurized.

The Applicant has verified that the use of nitrous oxide as an oxidizer together with a suitable fuel that is naturally green and self-pressurizing (e.g. propylene) in a thruster for orbital maneuvers has flame front temperatures higher than 2800° C.

The Applicant has verified that even using materials currently available and particularly suitable to withstand high temperatures to make a thruster for orbital maneuvers with additive manufacturing techniques, the flame front temperature using nitrous oxide could be such that an ignition time necessary for the completion of a phase of the mission would not be allowed because of the melting or degradation of the combustion chamber.

The Applicant has perceived that if directly exposing the combustion chamber walls to the flame front was avoided, the time necessary for degrading the combustion chamber would be increased and it would be possible to ignite the thruster for a time necessary for completing a phase of the mission.

The Applicant has found that by introducing the fuel and the oxidizer into the combustion chamber in such a way that they contact the walls of the combustion chamber in a stoichiometric ratio not useful for developing combustion and that, subsequently, they reach a volume of the combustion chamber distal from (or in any case not placed in direct contact with) the walls of the combustion chamber where they are mixed in a stoichiometric ratio useful for combustion, the walls of the combustion chamber would not be directly hit by the flame front.

### SUMMARY

The present invention therefore concerns, in a first aspect thereof, a thruster for orbital maneuvers, comprising:
a divergent channel having an axial axis of symmetry;
a combustion chamber delimited laterally by a combustion chamber wall;
a throat interposed between the combustion chamber and the divergent channel to put the combustion chamber in fluid communication with the divergent channel;
an injection plate facing the combustion chamber;
a plurality of first injection channels in fluid communication with the combustion chamber, configured to inject into the combustion chamber a first combustion component, wherein each first injection channel of said plurality of first injection channels comprises an end portion placed at the injection plate and open in the combustion chamber;
at least one second injection channel in fluid communication with the combustion chamber, configured to inject into the combustion chamber a second combustion component, and comprising an end portion placed at the injection plate and open in the combustion chamber;
wherein the end portions of the first injection channels of said plurality of first injection channels are placed substantially adjacent to an edge joint between the injection plate and the combustion chamber wall, in an annular region having a centre crossed by said axis of symmetry, and extend along respective injection directions;
wherein the end portion of the at least one second injection channel is placed radially between said axis of symmetry and the end portions of the first injection channels of said plurality of first injection channels;
wherein the injection direction of the end portion of each first injection channel has an axial component directed toward the combustion chamber and a radial component directed toward the axis of symmetry.

In a second aspect thereof, the present invention concerns a propulsion system for orbital maneuvers comprising:
a thruster for orbital maneuvers according to the first aspect;
a first tank containing a first type propellant fluidly coupled to the first injection channels of said plurality of first injection channels;
a second tank containing a second type propellant fluidly coupled to said at least one second injection channel;
wherein said first combustion component and said second combustion component are of the self-pressurizing type.

In a third aspect thereof, the present invention concerns an orbital transport vehicle comprising a thruster for orbital maneuvers according to the first aspect.

The plurality of first injection channels allows the first combustion component to be injected into the combustion chamber along a substantially annular path.

The at least one second injection channel allows the second combustion component to be injected into the combustion chamber within the annular path of the first combustion component.

The Applicant deems that in this way the second combustion component does not mix immediately with the first combustion component but is, at least at the time of its introduction, internal to and separate from the first combustion component.

The injection direction of the end portion of each first injection channel has an axial component directed toward the combustion chamber and a radial component directed toward the axis of symmetry so as to orient the jets of first combustion component entering the combustion chamber toward the axis of symmetry. In this way, the first combustion component injected into the combustion chamber converges toward the axis of symmetry and toward the second combustion component.

The Applicant deems that in this way the combustion takes place in a central region of the combustion chamber and that the first combustion component not yet mixed with the second combustion component is between the wall and the central region of the combustion chamber flowing at least in a first part of the combustion chamber, adhering to the wall of the combustion chamber itself and interposing itself between it and the flame front, preventing the latter from coming into direct contact with the wall of the combustion chamber.

The divergent channel has an axis of symmetry. In the present description and in the appended claims, expressions such as “axial”, “axially”, “radial”, “radially”, “radially inner”, “radially outer”, “circumferential”, “circumferentially”, “tangential”, “tangentially” are used with reference to this axis of symmetry.

The terms “radial” and “axial” and the expressions “radially inner/outer” and “axially inner/outer” are used with reference respectively to a perpendicular direction and to a direction parallel to the axis of symmetry of the divergent channel.

The expressions “radially innermost” and “radially outermost” indicate a position respectively closer to, and further away from, the axis of symmetry of the divergent channel.

The terms “circumferential” and “circumferentially” are used with reference to a direction along a circumference lying on a plane perpendicular to the axis of symmetry of the divergent channel and having a centre crossed by the axis of symmetry of the divergent channel.

The terms “tangential” and “tangentially” are used to indicate a direction tangent to a circumference lying on a plane perpendicular to the axis of symmetry of the divergent channel and having a centre crossed by the axis of symmetry of the divergent channel. This tangent direction is contained in the same plane in which said circumference lies.
In the present description and in the appended claims, the expressions “first combustion component” and “second combustion component” are understood to mean respective substances which, if suitably mixed together and if an activation energy is supplied to said mixture, give rise to an exothermic redox reaction.

The expression “injection plate” is understood to mean a portion of thruster facing the combustion chamber, opposite the throat, from which the first combustion component and the second combustion component are injected into the combustion chamber.

The present disclosure, in at least one of the aforementioned aspects, may be implemented according to one or more of the following embodiments, possibly combined with each other.

Peferebly, the first combustion component is an oxidizer.

Preferably, the first combustion component comprises Nitrous Oxide (N2O).

Preferably, the first combustion component is nitrous oxide.

Preferably, the second combustion component is a fuel.

Preferably, the second combustion component comprises propylene (C3H6).

Preferably, the second combustion component is propylene.

Preferably, said end portions of the first injection channels are straight.

Preferably, each end portion of the first injection channels is a stretch of a single channel.

Preferably, said end portions of the first injection channels are without branches.

Preferably, said end portions of the first injection channels have a constant cross-section along the injection direction.

Preferably, said first injection channels are straight.

Preferably, each first injection channel is a single channel.

Preferably, said first injection channels are without branches.

Preferably, said first injection channels have a constant cross-section along the injection direction.

Preferably, the end portion of each first injection channel has a diameter comprised between 0.5 mm and 0.9 mm, more preferably between 0.6 mm and 0.8 mm, even more preferably between 0.65 mm and 0.75 mm, for example 0.7 mm.

Preferably, the end portion of the at least one second injection channel is straight.

Preferably, the end portion of the at least one second injection channel is a stretch of a single channel.

Preferably, the end portion of the at least one second injection channel is without branches.

Preferably, the end portion of the at least one second injection channel has a constant cross-section along the injection direction.

Preferably, the at least one second injection channel is straight.

Preferably, the at least one second injection channel is a single channel.

Preferably, the at least one second injection channel is without branches.

Preferably, the at least one second injection channel has a constant cross-section along the injection direction.

Preferably, the end portion of each second injection channel has a diameter comprised between 0.4 mm and 0.8 mm, more preferably between 0.5 mm and 0.7 mm, even more preferably between 0.55 mm and 0.65 mm, for example 0.6 mm. Preferably, said combustion chamber wall is extended from the injection plate to the throat.

Preferably, said combustion chamber wall and said injection plate are joined to each other by an edge joint.

Preferably, at said edge joint said injection plate and said combustion chamber wall form an edge angle.

Preferably, said edge angle is comprised between 80° and 100°, more preferably between 85° and 95°, for example of about 90°.

Preferably, said annular region is delimited by an inner circumference and an outer circumference.

Preferably, said inner circumference and said outer circumference are concentric.

Preferably, said outer circumference is placed at said edge joint.

Preferably, said inner circumference of the annular region has a radius equal to or greater than 75%, more preferably equal to or greater than 85%, of the radius of the outer circumference.

Preferably, the first combustion component is injected in proximity to the combustion chamber wall.

Preferably, the end portion of the at least one second injection channel is placed between the inner circumference of the annular region and the axis of symmetry.

The end portion of the at least one second injection channel is placed outside the annular region defined between the inner circumference and the outer circumference.

In this way, the first combustion component is injected far away from the combustion chamber wall.

Preferably, the injection direction of the end portion of each first injection channel does not comprise any component directed along a tangential direction.

Preferably, the first combustion component is injected toward a point or a zone placed along the axis of symmetry.

Preferably, the first combustion component is injected into the combustion chamber from the end portions of the first injection channels in jets which form a conical distribution.

In this way, said second combustion component tends to be retained within said conical distribution of the first combustion component.

Preferably, the end portion of the at least one second injection channel extends along a respective injection direction having an axial component directed toward the combustion chamber.

In one embodiment, the injection direction of the end portion of the at least one second injection channel does not comprise any component directed along a radial direction.

In a different embodiment, the injection direction of the end portion of the at least one second injection channel comprises a radial component directed toward the axis of symmetry.

In a further different embodiment, the injection direction of the end portion of the at least one second injection channel comprises a radial component directed on the opposite side with respect to the axis of symmetry. Preferably, the injection direction of the end portion of the at least one second injection channel does not comprise any component directed along a tangential direction.

In this way, the second combustion component is injected parallel to the axis of symmetry, directly toward the central region of the combustion chamber where it is wished to have the combustion.

Alternatively, the injection direction of the end portion of the at least one second injection channel comprises a component directed along a tangential direction.

In this way, the second combustion component is injected into the combustion chamber with a rotary motion around the axis of symmetry that contributes to keeping the combustion far away from the injection plate and from the components mounted thereon.

Preferably, a projection on a plane containing said axis of symmetry of the injection direction of the end portion of each first injection channel of the plurality of first injection channels forms an angle with respect to said axis of symmetry comprised between 20° and 60°, preferably comprised between 30° and 50°, more preferably comprised between 35° and 45°, for example of about 40°. This angle can be calculated as the arctangent of the ratio between the radial component and the axial component of the injection direction.

Preferably, the injection direction of the end portion of each first injection channel of the plurality of first injection channels forms an angle with respect to a plane orthogonal to the axis of symmetry comprised between 30° and 70°, preferably comprised between 40° and 60°, more preferably comprised between 45° and 55°, for example of about 50°.

The Applicant has found that these angular values are particularly effective in keeping the combustion contained in the central region of the combustion chamber and far away from the wall of the combustion chamber.

Preferably, the first injection channels of the plurality of first injection channels are in a number comprised between seven and twenty-eight, preferably between ten and twenty-two, even more preferably between thirteen and sixteen, for example fourteen.

Preferably, a projection on a plane containing said axis of symmetry of the injection direction of the end portion of the at least one second injection channel forms an angle with respect to said axis of symmetry comprised between 0° and 20°, preferably comprised between 0° and 10°, more preferably comprised between 0° and 5°. This angle can be calculated as the arctangent of the ratio between the radial component (directed toward the axis of symmetry or on the opposite side to the axis of symmetry) and the axial component of the second injection direction.

Preferably, the injection direction of the end portion of the at least one second injection channel forms an angle with respect to a plane orthogonal to the axis of symmetry comprised between 70° and 90°, preferably comprised between 80° and 90°, more preferably comprised between 85° and 90°. If the angle is different from 90°, the injection direction of the end portion of the at least one second injection channel is incident with the axis of symmetry or is divergent with respect to the axis of symmetry.

Preferably, there is provided a plurality of second injection channels.

Preferably, the second injection channels of the plurality of second injection channels are in a number comprised between two and eight, preferably between three and six, for example four.

Preferably, the second injection channels have a smaller cross-section than the first injection channels.

Preferably, the second injection channels are distributed along a circumference centred on said axis of symmetry, preferably equidistant from each other.

Preferably, there is provided a spark plug mounted in the injection plate at said axis of symmetry and configured to generate a spark in the combustion chamber.

Alternatively, it may be provided for a plurality of spark plugs mounted on the injection plate which are equidistant with respect to said axis of symmetry and configured to generate sparks in the combustion chamber.

Preferably, there is provided a plurality of cooling channels arranged around the combustion chamber and in fluid connection with said first injection channels.

Preferably, the cooling channels of the plurality of cooling channels are in a number comprised between fourteen and eighteen, more preferably between fifteen and seventeen, for example sixteen.

The cooling channels further cool the combustion chamber wall and preheat the first combustion component.

Preferably, the cooling channels of the plurality of cooling channels are incorporated in the combustion chamber wall.

Preferably, the cooling channels of the plurality of cooling channels are fluidly couplable with a first tank, the cooling channels being configured to receive the first combustion component from the first tank prior to the introduction of the first combustion component into the combustion chamber.

Preferably, the cooling channels are configured to make the first combustion component flow in the combustion chamber wall in a cooling direction directed from the throat toward the injection plate.

Preferably, there is provided a first distribution channel arranged at the injection plate and configured to receive said first combustion component, said first injection channels extending from said first distribution channel to said combustion chamber.

Preferably, the first distribution channel has an annular shape and is placed around said axis of symmetry.

Preferably, there is provided a second distribution channel arranged at the injection plate and configured to receive said second combustion component, said at least one second injection channel extending from said second distribution channel to said combustion chamber.

Preferably, the second distribution channel has an annular shape and is placed around said axis of symmetry.

Preferably, the second distribution channel is radially internal to the first distribution channel.

In one embodiment, there is provided a cylindrical slit defined in the injection plate around the axis of symmetry and facing onto said combustion chamber.

Preferably there is provided a plurality of further injection channels having respective end portions facing within said cylindrical slit and configured to inject within said cylindrical slit said first injection component and/or said second injection component with a rotary motion around said axis of symmetry.

Preferably, each end portion of said further injection channels extends along a respective injection direction tangent to the cylindrical slit.

Preferably, there is provided a block of material made as a single piece.

Preferably, said divergent channel, combustion chamber, throat, injection plate, plurality of first injection channels and at least one second injection channel are defined in said block.

Preferably, at least part of said thruster is made by said block.

Preferably said block is made by additive manufacturing.

Preferably said block is made by selective metal laser melting.

Preferably said block is made of Inconel® 718.

### BRIEF DESCRIPTION OF THE DRAWINGS

The characteristics and advantages of the present disclosure will result from the following detailed description of some embodiment examples thereof, provided by way of non-limiting example only, a description that will be conducted by reference to the appended drawings, in which:

FIG. 1 shows a schematic view of a propulsion system for orbital maneuvers in accordance with the present invention;

FIG. 2 shows a perspective view of a thruster for orbital maneuvers in accordance with the present invention, with some components removed for clarity's sake;

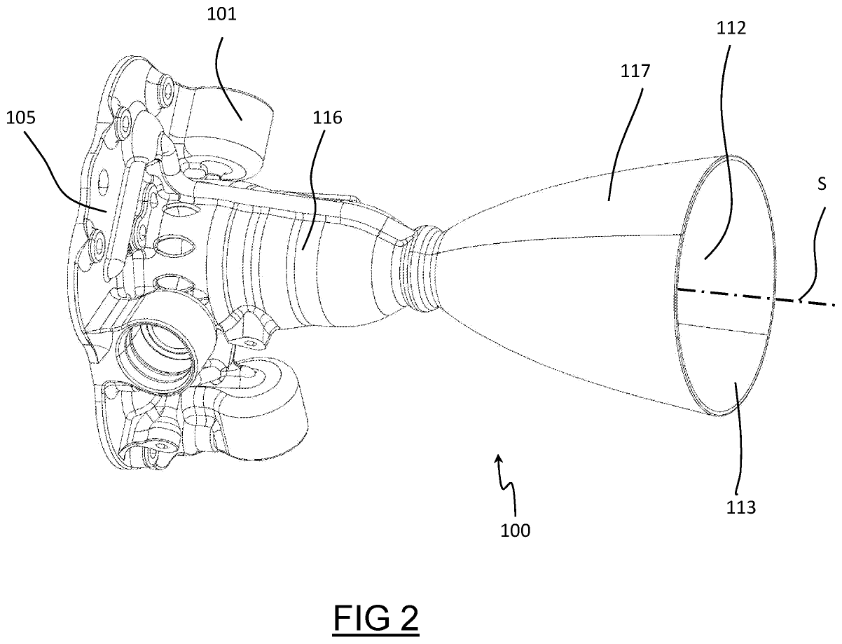

FIG. 3 shows a sectional view of the thruster for orbital maneuvers of FIG. 2 in a first cutting plane;

FIG. 4 shows a sectional view of the thruster for orbital maneuvers of FIG. 2 in a second cutting plane different from the first cutting plane;

FIG. 5 shows an enlargement of the section of FIG. 4;

FIG. 6 shows a sectional view of the thruster for orbital maneuvers of FIG. 2 in a third cutting plane orthogonal to the first cutting plane and to the second cutting plane;

FIG. 7 shows a sectional view of the thruster for orbital maneuvers of FIG. 2 in a fourth cutting plane different from the first cutting plane and from the second cutting plane and orthogonal to the third cutting plane.

### DETAILED DESCRIPTION

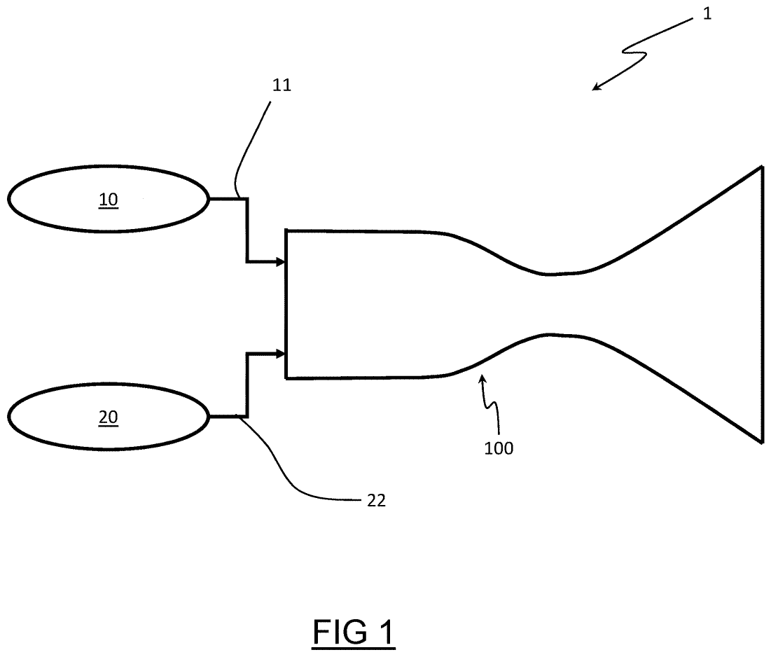

A propulsion system for orbital maneuvers, object of the present invention, is schematically represented in FIG. 1, where it is indicated by reference numeral 1.

The propulsion system 1 comprises a first tank 10, a second tank 20 and a thruster 100 for orbital maneuvers fluidly coupled to the first tank 10 and to the second tank 20.

The first tank 10 contains a first combustion component, in particular an oxidizer. The first combustion component is a self-pressurizing substance, contained in the first tank 10 in at least partially liquid form, so as to maintain in the first tank 10 a pressure equal to its evaporation pressure. In the preferred embodiment the oxidizer is nitrous oxide (N2O).

A first feeding channel 11 is fluidly connected to the first tank 10 for receiving therefrom the first combustion component at the evaporation pressure of the first combustion component. The first feeding channel 11 extends from the first tank 10 to the thruster 100.

A pair of valves, not illustrated, is arranged along the first feeding channel 11 to regulate the flow of first combustion component.

The second tank 20 contains a second combustion component configured to react with the first combustion component to generate a combustion, in particular a fuel. The second combustion component is a self-pressurizing substance, contained in the second tank 20 in at least partially liquid form, so as to maintain in the second tank 20 a pressure equal to its evaporation pressure. In the preferred embodiment the fuel is propylene.

A second feeding channel 21 is fluidly connected to the second tank 20 for receiving therefrom second type propellant at the evaporation pressure of the second type propellant. The second feeding channel 21 extends from the first tank 20 to the thruster 100.

A pair of valves, not illustrated, is arranged along the second feeding channel 21 to regulate the flow of second combustion component.

The thruster 100 comprises a block 101 of material made as a single piece by additive manufacturing. The preferred manufacturing material of the block 101 is a nickel alloy. In the preferred embodiment the material is commercially known as INCONEL® 718. This material comprises (values in % by weight):
50.00-55.00 nickel with added cobalt;
17.00-21.00 chromium;
4.75-5.50 tantalum-added niobium
2.80-3.30 molybdenum;
0.65-1.15 titanium;
0.20-0.80 aluminium;
0 -1.00 cobalt;
0 -0.80 carbon;
0-0.35 manganese;
0-0.35 silicon;
0-0.015 phosphorus;
0-0.015 sulfur;
0-0.006 boron;
0 -0.30 copper;
Iron to balance.

The thruster 100 comprises a fixing portion 105 by which the thruster 100 can be further mounted in a fixed manner to an orbital vehicle. The fixing portion 105 is defined in the block 101.

The thruster 100 comprises a combustion chamber 110, a divergent channel 111, and a throat 112 arranged between the combustion chamber 110 and the divergent channel 111 to put the combustion chamber 110 and the divergent channel 111 in fluid communication with.

The combustion chamber 110 comprises a first substantially cylindrical region 110a and a second region 110b adjacent to the first region 110a and convergent toward the throat 112.

The throat 112 defines a sonic choke between the combustion chamber 110 and the divergent channel 111 so as to form, with the second region 110b and the divergent channel 111, a supersonic convergent-divergent nozzle.

The divergent channel 111 is preferably sized to operate in the vacuum and has an inlet at the throat 112 and an outlet 113 on the opposite side with respect to the throat 112. The divergent channel 111 is configured to expel through the outlet 113 a supersonic jet coming from the combustion chamber 110 and directed on the opposite side with respect to the fixing portion 105. The divergent channel 111 has an axis of symmetry S.

The combustion chamber 110 is preferably also symmetrical with respect to the axis of symmetry S. The throat 112 is preferably also symmetrical with respect to the axis of symmetry S. Such symmetries are preferably of a cylindrical type.

The combustion chamber 110, the divergent channel 111, and the throat 112 are defined in the block 101.

An injection plate 115 faces the combustion chamber 110, in particular the first region 110a. The injection plate 115 is placed axially between the fixing portion 105 and the combustion chamber 110. The combustion chamber 110 is delimited axially by the injection plate 115 on the opposite side with respect to the throat 112 along the axis of symmetry S. The injection plate 115 has a circular shape, is preferably flat and oriented orthogonally to the axis of symmetry S. The injection plate 115 is defined in the block 101.

The combustion chamber 110 is delimited laterally by a combustion chamber wall 116. The combustion chamber wall 116 extends from the injection plate 115 to the throat 112. The combustion chamber wall 116 is symmetrical with respect to the axis of symmetry S. The combustion chamber wall 116 is defined in the block 101.

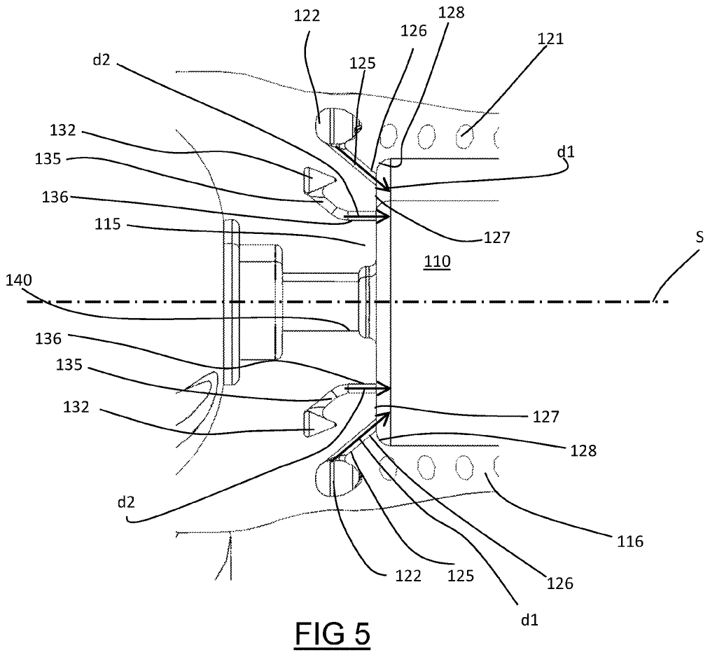

The combustion chamber wall 116 forms an edge joint 128 (illustrated in FIG. 5) with the injection plate. Such an edge joint 128 has an edge angle comprised between 80° and 100°, more preferably between 85° and 95°, for example of about 90°. The edge joint 128 has a circular shape with a centre placed on the axis of symmetry S.

The divergent channel 111 is delimited laterally by a divergent channel wall 117. The divergent channel wall 117 extends from the combustion chamber wall 116 on the opposite side with respect to the combustion chamber 110. The divergent channel wall 117 is symmetrical with respect to the axis of symmetry S. The divergent channel wall 117 is defined in the block 101.

The combustion chamber 110 is fluidly connectable to the first tank 10.

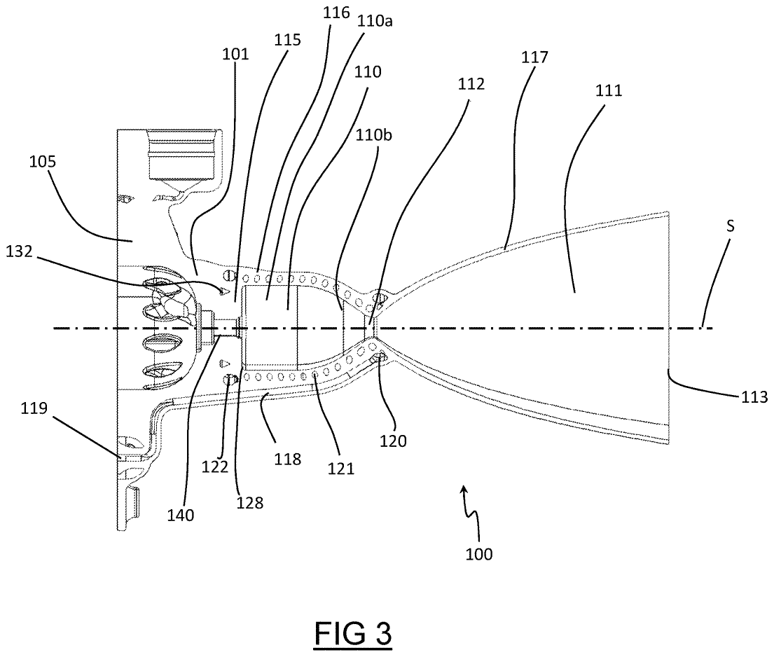

The thruster 100 comprises a first connection channel 118, illustrated in FIG. 3, fluidly connectable to the first feeding channel 11 for receiving therefrom the first combustion component coming from the first tank 10. The first connection channel 118 is defined in the block 101.

The first connection channel 118 comprises a first coupling portion 119 at the fixing portion 105 and fluidly connectable in a sealed manner to the first feeding channel 11.

An annular throat channel 120 is arranged at the throat 112. The annular throat channel 120 is defined in the block 101. The annular throat channel 120 is arranged around the throat 112, symmetrical with respect to the rotation axis S.

The first connection channel 118 extends from the first coupling portion 119 along the combustion chamber wall 116 up to the annular throat channel 120.

In the combustion chamber wall 116 a plurality of cooling channels 121 are made which are fluidly couplable to the first type tank 10 for receiving first combustion component prior to the introduction into the combustion chamber 110. The plurality of cooling channels 121 is defined in the block 101. The plurality of cooling channels 121 is incorporated in the combustion chamber wall 116, buried therein. Within the plurality of cooling channels 121, the first combustion component subtracts heat from the combustion chamber wall 116 heating itself in preparation for insertion into the combustion chamber.

A first distribution channel 122 is arranged around the injection plate 115. The first distribution channel 122 is defined in the block 101. The first distribution channel 122 has an annular shape and is symmetrical with respect to the axis of symmetry S.

The cooling channels 121 extend from the annular throat channel 120 to the first distribution channel 122.

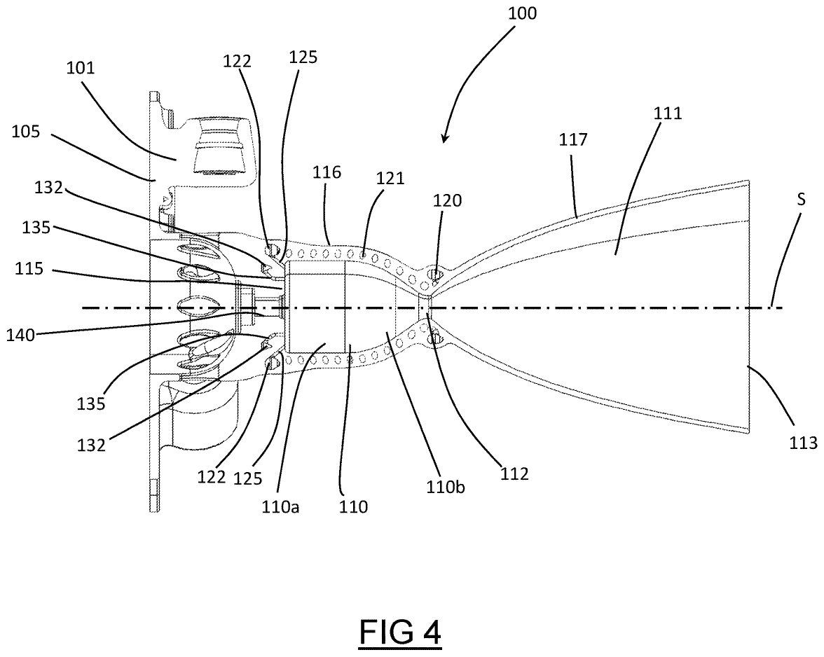

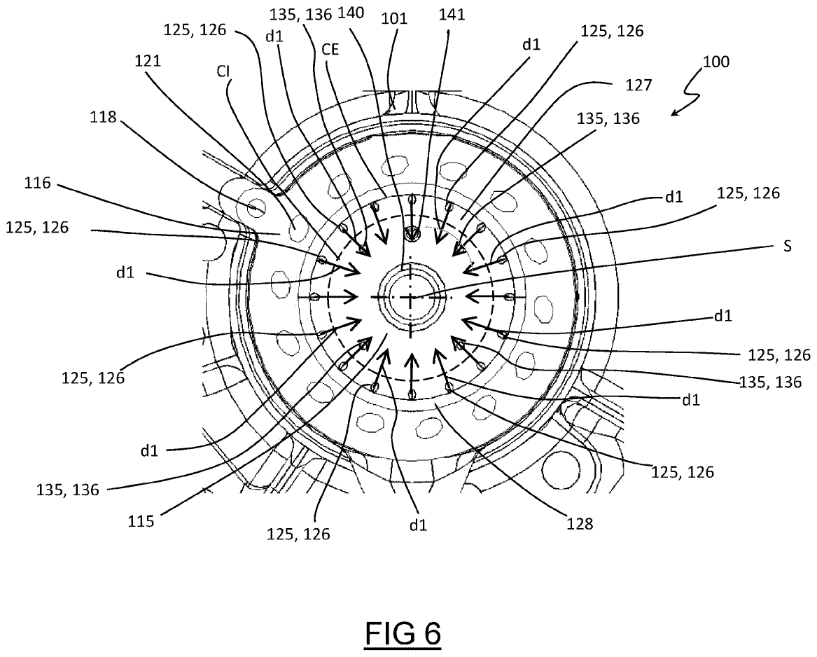

A plurality of first injection channels 125, illustrated in FIGS. 4, 5 and 6, are configured to inject into the combustion chamber 110 the first combustion component. The first injection channels 125 are extended from the first distribution channel 122 to the combustion chamber 110.

The first injection channels 125 are in a number comprised between seven and twenty-eight, preferably between ten and twenty-two, even more preferably between thirteen and sixteen, preferably fourteen.

The first injection channels 125 are fluidly couplable to the first tank 10. To inject the first combustion component into the combustion chamber 110, the first combustion component passes through the first coupling portion 119, the first connection channel 118, the annular throat channel 120, the cooling channels 121, the first distribution channel 122 and the first injection channels 125, preferably in the order in which they are listed.

Preferably, the first injection channels 125 are between them equally long.

Each first injection channel 125 comprises an end portion 126 placed at the injection plate 115 and open in the combustion chamber 110.

The end portions 126 are located in an annular region 127 defined on the injection plate 115 and centred on the axis of symmetry S. Each end portion 126 has a respective outlet section facing the combustion chamber 110 entirely contained in the annular region 127.

The annular region 127 is delimited externally by an outer circumference CE defined at the combustion chamber wall 116. The outer circumference CE is defined at the edge joint 128 between the injection plate 115 and the combustion chamber wall 116, in particular at its joint. In other words, the outer circumference CE has a radius substantially equal to the radius of the injection plate 115.

The annular region 127 is delimited internally by an inner circumference CI defined on the injection plate 115 between the edge joint 128 and the axis of symmetry S. Preferably, the radius of the inner circumference CI is at least 75% of the outer radius, preferably at least 85%.

The end portions 126 are distributed circumferentially in the annular region 127. The end portions 126 are angularly equidistant with respect to the axis of symmetry S. In the illustrated embodiment, the end portions 126 are placed substantially adjacent to the edge joint 128 between the injection plate 118 and the combustion chamber wall 116.

Each first injection channel 125 extends between the injection plate 115 and the combustion chamber 110 without branches. At least the end portions 126 of the first injection channels 125 are straight. Preferably the first injection channels 125 are entirely straight. At least the end portions 126 of the first injection channels 125 have a constant cross-section. Preferably the first injection channels 125 have a constant cross-section along their entire length.

Each end portion 126 has a respective injection direction d1 which coincides with its main extension axis. The injection direction substantially determines the injection direction of the first combustion component in the combustion chamber 110. In the illustrated preferred embodiment, the injection direction d1 coincides with the main extension axis of the respective entire injection channel 125.

The injection direction d1 has, with respect to the axis of symmetry S, an axial component parallel to the axis of symmetry S, directed toward the combustion chamber 110.

The injection direction d1 further has a radial component of the injection direction d1, is directed toward the axis of symmetry S. In other words at least the end portion 126 of each injection channel 125 is inclined toward the axis of symmetry S approaching the combustion chamber 110.

In the illustrated embodiment, the injection direction d1 of each end portion 126 has no tangential component. In other words, the tangential component of the injection direction d1 is null.

The injection directions d1 of the end portions 126 are incident with the axis of symmetry S, preferably at an intersection point common to all the injection directions d1.

Preferably, the injection direction d1 of each end portion 126 has an angle comprised between 20° and 60° with respect to the axis of symmetry S, even more preferably comprised between 30° and 50°, even more preferably comprised between 35° and 45°. In the illustrated embodiment, this angle is 40°.

In alternative embodiments not illustrated, the tangential component of the injection direction d1 of one or more end portions 126 is other than zero. In this way, a motion of the first combustion component injected into the combustion chamber 110 of rotation around the axis of symmetry S is determined.

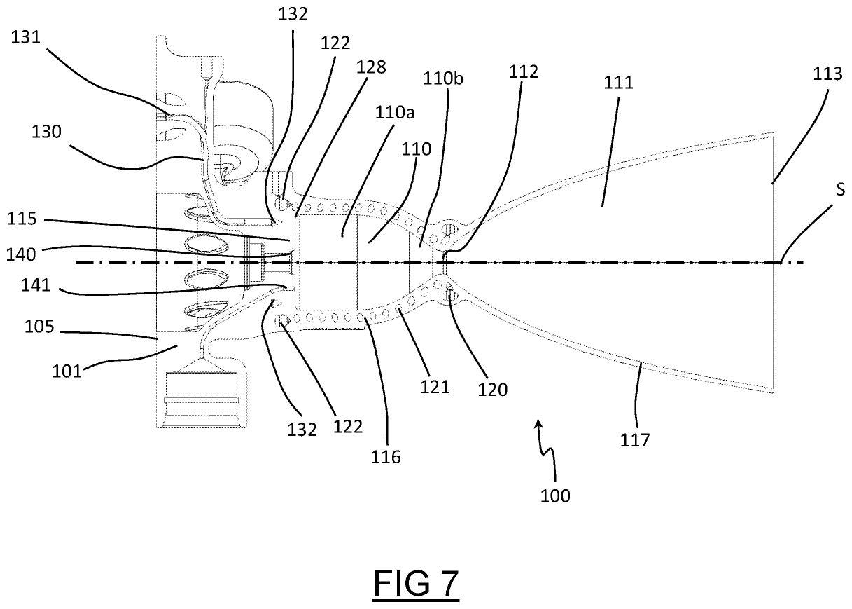

The thruster 100 comprises a second connection channel 130, illustrated in FIG. 7, fluidly connectable to the second feeding channel 21 for receiving therefrom the second combustion component coming from the second tank 20. The second connection channel 130 is defined in the block 101.

The second connection channel 130 comprises a second coupling portion 131 at the fixing portion 105 and fluidly connectable in a sealed manner to the second feeding channel 21.

A second distribution channel 132 is arranged at the injection plate 115. The second distribution channel 132 is defined in the block 101. The second distribution channel 132 is annular and symmetrical with respect to the axis of symmetry S. The second distribution channel 132 is radially internal with respect to the first distribution channel 122. Preferably, the second distribution channel 132 has a triangular section in a cutting plane containing the axis of symmetry S.

The second connection channel 130 extends from the second coupling portion 131 to the second distribution channel 132.

At least one second injection channel 135 is configured to inject into the combustion chamber 110 the second combustion component. Preferably, there is provided a plurality of second injection channels 135. Preferably, the second injection channels 135 are in a number comprised between two and eight, even more preferably between three and six. In the embodiment illustrated in FIGS. 4, 5 and 6, there are provided four second injection channels 135.

The second injection channels 135 are extended from the second distribution channel 132 to the combustion chamber 110.

The second injection channels 135 are fluidly couplable to the second tank 20. To inject the second combustion component into the combustion chamber 110, the second combustion component passes through the second coupling portion 131, the second connection channel 130, the second distribution channel 132 and the second injection channels 135, preferably in the order in which they are listed.

Preferably, the second injection channels 135 are between them equally long.

Each second injection channel 135 comprises an end portion 136 placed at the injection plate 115 and open in the combustion chamber 110.

The end portions 136 of the second injection channels 135 are located radially between the end portions 126 of the first injection channels 125 and the axis of symmetry S. In other words, the end portions 136 of the second injection channels 135 are located radially internal with respect to the end portions 126 of the first injection channels 125.

Preferably, the end portions 136 of the second injection channels 135 are located radially internal with respect to the annular region 127. In other words, each end portion 136 has a respective outlet section facing the combustion chamber 110 entirely arranged radially internal to the inner circumference CI of the annular region 127.

The end portions 136 of the second injection channels 135 are equidistant from the axis of symmetry S. The end portions 136 of the second injection channels 135 are distributed circumferentially around the axis of symmetry S. The end portions 136 of the second injection channels 135 are angularly equidistant with respect to the axis of symmetry S.

Each second injection channel 135 extends between the injection plate 115 and the combustion chamber 110 without branches. At least the end portions 136 of the second injection channels 135 are straight. At least the end portions 136 of the second injection channels 135 have a constant cross-section. Preferably the second injection channels 135 have a constant cross-section along their entire length.

Each end portion 136 has a respective injection direction d2 which coincides with its main extension axis. The injection direction d2 substantially determines the injection direction of the second combustion component in the combustion chamber 110. In the illustrated preferred embodiment, the injection direction d2 coincides with the main extension axis of the respective entire injection channel 135.

The injection direction d2 of each end portion 136 has an axial component parallel to the axis of symmetry S, directed toward the combustion chamber 110. In a preferred embodiment, the injection direction d2 of each end portion 136 has no radial component. In other words, the injection direction d2 of each end portion 136 has null radial component. Preferably, the injection direction d2 of each end portion 136 has no tangential component. In other words, the injection direction d2 of each end portion 136 has null tangential component. The injection directions d2 of the end portions 136 are therefore parallel to the axis of symmetry S.

In alternative embodiments not illustrated, the radial component of the injection direction d2 of the one or more end portions 136 is other than zero. The injection directions d2 of the end portions 136 may be incident with the axis of symmetry S, preferably at an intersection point common to all the injection directions d2. Alternatively, the injection directions d2 of the end portions 136 may be divergent with the axis of symmetry S. Preferably, the injection direction d2 of each end portion 136 has an angle, convergent or divergent with the axis of symmetry S, comprised between 0° and 20° with respect to the axis of symmetry S, even more preferably comprised between 0° and 10°, even more preferably comprised between 0° and 5°. In this way, the second combustion component is injected into the combustion chamber 110 with a motion that moves towards the axis of symmetry S, or that moves away from the axis of symmetry S, with an angle comprised between 0° and 20° with respect to the axis of symmetry S, even more preferably comprised between 0° and 10°, even more preferably comprised between 0° and 5°. The angle 0° indicates that the injection direction d2 has no radial component.

In alternative embodiments not illustrated, the tangential component of the injection direction d2 of the one or more end portions 136 is other than zero. In this way, the second combustion component is injected into the combustion chamber 110 with a motion of rotation around the axis of symmetry S.

The thruster 100 further comprises at least one spark plug, not illustrated, mounted in the injection plate 115 facing the combustion chamber 110. The spark plug is configured to generate a spark in the combustion chamber 110 so as to initiate the combustion between the first combustion component and the second combustion component in the combustion chamber 110.

The spark plug is mounted in a first seat 140 defined in the block 101 at the axis of symmetry S. The first seat 140 is cylindrical.

Alternatively, in embodiments not illustrated, a plurality of spark plugs may be provided mounted on the injection plate which are equidistant with respect to the axis of symmetry S.

The thruster 100 further comprises a pressure sensor, not illustrated, mounted in the injection plate 115 facing the combustion chamber 110. The pressure sensor is configured to measure the pressure in the combustion chamber 110 so as to control the combustion.

The signal of the pressure sensor may be used to feedback regulate the flow rate of first combustion component from the first tank 10 and the flow rate of second combustion component from the second tank 20.

The pressure sensor is mounted in a second seat 141 defined in the block 101. The second seat 141 is defined radially between the end portions 136 of the second injection channels 135 and the axis of symmetry S. The second seat 141 is defined radially external to the first seat 140.

In one embodiment not illustrated, there is provided a cylindrical slit extended around the axis of symmetry S, in particular around the first seat 140 for the spark plug, and facing in the combustion chamber 110.

A plurality of further injection channels, not illustrated, are placed in fluid connection with the cylindrical slit so that the respective end portions are tangent to the slit itself. The further injection channels are configured to inject into the cylindrical slit the first combustion component and the second combustion component so as to impart to it a circumferential motion inside the slit. The first combustion component and the second combustion component can thus escape from the slit, partially or completely mixed, forming a vortex in the combustion chamber 110 around the axis of symmetry S. The vortex is introduced into the combustion chamber 110 at the spark plug. This facilitates the ignition of the mixture of first combustion component and second component by means of the spark plug and, at the same time, moves the combustion away from the spark plug so as to avoid subjecting it to too high temperatures.

The above-described propulsion system 1, comprising the thruster 100, may be mounted in a fixed manner on an orbital transport vehicle, not illustrated, configured to move on a given orbit to release a payload. The propulsion system 1 may for example be activated to transfer the orbital transport vehicle from a release orbit in which the orbital transport vehicle is released by a launcher, to a deployment orbit in which a payload is deployed by the orbital transport vehicle.

The propulsion system 1 may further be activated to transfer the orbital transport vehicle from a first deployment orbit in which a first payload is deployed by the orbital transport vehicle to a second deployment orbit in which a second payload is deployed by the orbital transport vehicle.

The propulsion system 1 may still be activated to transfer the orbital transport vehicle from a deployment orbit in which the payload is deployed by the orbital transport vehicle to a re-entry orbit in which the orbital transport vehicle is in a re-entry trajectory into the atmosphere.

1. A thruster for orbital maneuvers, comprising:
a divergent channel having an axial axis of symmetry;
a combustion chamber delimited laterally by a combustion chamber wall;
a throat interposed between the combustion chamber and the divergent channel to put the combustion chamber in fluid communication with the divergent channel;
an injection plate facing the combustion chamber;
a plurality of first injection channels in fluid communication with the combustion chamber, configured to inject into the combustion chamber a first combustion component, wherein each first injection channel of said plurality of first injection channels comprises an end portion placed at the injection plate and open in the combustion chamber;
at least one second injection channel in fluid communication with the combustion chamber, configured to inject into the combustion chamber a second combustion component, and comprising an end portion placed at the injection plate and open in the combustion chamber;
wherein the end portions of the first injection channels of said plurality of first injection channels are placed substantially adjacent to an edge joint between the injection plate and the combustion chamber wall, in an annular region having a centre crossed by said axis of symmetry, and extend along respective injection directions;
wherein the end portion of the at least one second injection channel is placed radially between said axis of symmetry and the end portions of the first injection channels of said plurality of first injection channels;
wherein the injection direction of the end portion of each first injection channel of said plurality of first injection channels has an axial component directed toward the combustion chamber and a radial component directed toward the axis of symmetry.

2. The thruster for orbital maneuvers according to claim 1, comprising a block of material made as a single piece, said divergent channel, said combustion chamber, said throat said injection plate, said plurality of first injection channels and said at least one second injection channel being defined in said block.

3. The thruster for orbital maneuvers according to claim 2, wherein said annular region is delimited by an inner circumference and an outer circumference which are concentric, wherein said outer circumference is placed at said edge joint, and wherein said inner circumference of the annular region has a radius equal to or greater than 75%, more preferably equal to or greater than 85%, of the radius of the outer circumference.

4. The thruster for orbital maneuvers according to claim 1, wherein said annular region is delimited by an inner circumference and an outer circumference which are concentric and the end portion of the at least one second injection channel is placed between the inner circumference and the axis of symmetry.

5. The thruster for orbital maneuvers according to claim 1, wherein the injection direction of the end portion of each first injection channel does not comprise any component directed along a tangential direction.

6. The thruster for orbital maneuvers according to claim 1, wherein the end portion of the at least one second injection channel extends along a respective injection direction and wherein the a projection on a plane containing said axis of symmetry of the injection direction of the end portion of the at least one second injection channel forms an angle with respect to said axis of symmetry comprised between 0° and 20°.

7. The thruster for orbital maneuvers according to claim 1, wherein the a projection on a plane containing said axis of symmetry of the injection direction of the end portion of each first injection channel of the plurality of first injection channels forms an angle with respect to said axis of symmetry comprised between 20° and 60°.

8. The thruster for orbital maneuvers according to claim 1, wherein the a projection on a plane containing said axis of symmetry of the injection direction of the end portion of each first injection channel of the plurality of first injection channels forms an angle with respect to said axis of symmetry comprised between 30° and 60°.

9. The thruster for orbital maneuvers according to claim 1, wherein the a projection on a plane containing said axis of symmetry of the injection direction of the end portion of each first injection channel of the plurality of first injection channels forms an angle with respect to said axis of symmetry comprised between 35° and 60°.

10. The thruster for orbital maneuvers according to claim 1, comprising a plurality of second injection channels.

11. The thruster for orbital maneuvers according to claim 1, wherein the first injection channels of the plurality of first injection channels are in a number comprised between seven and twenty-eight.

12. The thruster for orbital maneuvers according to claim 1, comprising a spark plug mounted in the injection plate at said axis of symmetry and configured to generate a spark in the combustion chamber.

13. The thruster for orbital maneuvers according to claim 1, wherein said end portions of the first injection channels are straight, without branches, and have a constant cross-section along the injection direction.

14. The thruster for orbital maneuvers according to claim 1, wherein the injection direction of the end portion of each first injection channel of the plurality of first injection channels forms an angle with respect to a plane orthogonal to the axis of symmetry comprised between 30° and 60°.

15. The thruster for orbital maneuvers according to claim 1, wherein the injection direction of the end portion of each first injection channel of the plurality of first injection channels forms an angle with respect to a plane orthogonal to the axis of symmetry comprised between 30° and 55°.

16. The thruster for orbital maneuvers according to claim 1, wherein the injection direction of the end portion of the at least one second injection channel does not comprise any components directed along a radial direction.

17. A propulsion system for orbital maneuvers comprising:
the thruster for orbital maneuvers according to claim 1;
a first tank containing a first type propellant fluidly coupled to the first injection channels of said plurality of first injection channels;
a second tank containing a second type propellant fluidly coupled to said at least one second injection channel;
wherein said first combustion component and said second combustion component are of a self-pressurizing type.

18. An orbital transport vehicle comprising the thruster for orbital maneuvers according to claim 1.

19. The thruster for orbital maneuvers according to claim 1, wherein said annular region is delimited by an inner circumference and an outer circumference which are concentric,
wherein said outer circumference is placed at said edge joint,
and wherein said inner circumference of the annular region has a radius equal to or greater than 75% of the radius of the outer circumference.
